(19) United States
(12) Patent Application Publication
(10) Pub. No.: US 2026/0081048 A1
(43) Pub. Date: Mar. 19, 2026

(54) SPENT NUCLEAR FUEL DRY STORAGE CONTAINER HAVING INTERNAL OXYGEN AND MOISTURE REMOVAL FUNCTIONS

(71) Applicant: KOREA RADIOACTIVE WASTE AGENCY, Gyeongsangbuk-do (KR)

(72) Inventors: Seung Hyun KIM, Sejong (KR); Hyungoo KANG, Daejeon (KR); Sang Hwan LEE, Daejeon (KR); Sang Hyuk YUN, Daejeon (KR); Yun Jung CHOI, Daejeon (KR); Tae Chul MOON, Daejeon (KR)

(21) Appl. No.: 19/109,532

(22) PCT Filed: Sep. 19, 2023
(86) PCT No.: PCT/KR2023/014142

§ 371 Date: Mar. 6, 2025

(30) Foreign Application Priority Data
Sep. 20, 2022 (KR) 10-2022-0118476

(51) Int. Cl. G21F 5/008; G21F 5/12; H01T 13/08

(52) U.S. Cl. CPC G21F 5/008; G21F 5/12; H01T 13/08

(57) ABSTRACT

The present disclosure relates to a spent nuclear fuel dry container having internal oxygen and moisture removal functions. The spent nuclear fuel dry container having internal oxygen and moisture removal functions comprises an oxygen and moisture removal apparatus including: an oxygen removal unit capable of removing oxygen contained in the internal space; and a moisture removal unit capable of removing moisture contained in the internal space.

### CROSS REFERENCE TO RELATED APPLICATIONS

The present application is a U.S. National Phase of International Application No. PCT/KR2023/014142 entitled “SPENT NUCLEAR FUEL DRY STORAGE CONTAINER HAVING INTERNAL OXYGEN AND MOISTURE REMOVAL FUNCTIONS,” and filed on Sep. 19, 2023. International Application No. PCT/KR2023/014142 claims priority to Republic of Korea Patent Application No. 10-2022-0118476 filed on Sep. 20, 2022. The entire contents of each of the above-listed applications are hereby incorporated by reference for all purposes.

### TECHNICAL FIELD

The present disclosure relates to a spent nuclear fuel dry storage container having internal oxygen and moisture removal functions, and more particularly, to a spent nuclear fuel dry storage container having internal oxygen and moisture removal functions, which includes an oxygen and moisture removal apparatus to be able to safely store and seal spent nuclear fuel, and then remove oxygen and moisture remaining in the internal space.

### BACKGROUND ART

In general, radioactive waste refers to a material that contains radioactive nuclides of a specified concentration or more or is contaminated with the radioactive nuclides.

The radioactive waste generated or dismantled at a radioactive waste generation site may be transported to a radioactive waste disposal site such as a surface disposal facility located near the surface of the earth or a disposal facility located hundreds of meters underground from the surface of the earth and then isolated and disposed. In order to transport the radioactive waste to the final disposal site, it is necessary to store the radioactive waste in a special storage container such as a special container, a drum, or a large container, and then transport the radioactive waste.

In the conventional spent nuclear fuel storage container, when the spent nuclear fuel is accommodated in a space formed inside, the radioactive nuclides of the accommodated spent nuclear fuel are sealed to prevent leakage to the outside.

By connecting a gas suction apparatus, etc., to a valve, etc., that makes the internal space of the sealed spent nuclear fuel storage container and the outside communicate with each other, gas in the internal space of the spent nuclear fuel storage container is sucked to form the internal space into a vacuum state.

However, even if the internal space of the spent nuclear fuel storage container is formed into the vacuum state in this way, a tiny amount of oxygen and moisture remain in the internal space of the spent nuclear fuel storage container.

Generally, since the spent nuclear fuel storage container is formed of a metal material, when the tiny amount of oxygen and moisture remain in the internal space of the spent nuclear fuel storage container, the inside of the spent nuclear fuel storage container may be oxidized and corroded, and accordingly, nuclides may leak to the outside of the spent nuclear fuel storage container.

Therefore, it is necessary to find a method for removing oxygen and moisture remaining in an internal space of a sealed spent nuclear fuel storage container and preventing the spent nuclear fuel storage container from deteriorating.

### DISCLOSURE

### Technical Problem

An object of the present disclosure provides a spent nuclear fuel dry storage container having internal oxygen and moisture removal functions capable of removing oxygen remaining in an internal space.

Another object of the present disclosure provides a spent nuclear fuel dry storage container having internal oxygen and moisture removal functions capable of removing moisture remaining in an internal space.

Aspects of the present disclosure are not limited to the above-described aspects. That is, other aspects that are not described may be obviously understood by those skilled in the art from the following specification.

### Technical Solution

In one general aspect, a spent nuclear fuel dry storage container having internal oxygen and moisture removal functions for storing and transporting spent nuclear fuel includes: a main body that is formed to include a lower surface and side surfaces so that a space accommodating the spent nuclear fuel is formed inside, and opens upper surface; a lid that is fastened to the upper portion of the main body to seal the space; a valve that is installed on the lid, is opened and closed so as to make the space and an outside of the spent nuclear fuel dry storage container having internal oxygen and moisture removal functions communicate with each other when opened and isolate the space and the outside of the spent nuclear fuel dry storage container having internal oxygen and moisture removal functions from each other when closed, and is connectable to a gas suction apparatus so that the gas suction apparatus sucks the gas contained in the space; and an oxygen and moisture removal apparatus that is installed on the lid and includes an oxygen removal unit removing oxygen contained in the space and a moisture removal unit removing moisture contained in the space.

The oxygen removal unit may generate a flame and combust oxygen contained in the space, and the moisture removal unit may absorb moisture and remove moisture contained in the space.

The oxygen and moisture removal apparatus may be a spark plug including: a connecting part that includes a screw thread formed on an outer circumferential surface of one side thereof so as to be screw-connected with the lid; a sealing part that is installed in a portion in contact with the lid to seal the lid when screw-connected with the lid; an oxygen removal unit that generates the flame, and is installed at an end of one side thereof and located inside the space when the oxygen and moisture removal apparatus is connected to the lid; and a moisture removal unit that absorbs the moisture, and is installed between the sealing part and the oxygen removal unit and located inside the space when the oxygen and moisture removal apparatus is connected to the lid.

The moisture removal unit may be formed by coating silicon dioxide on an outer circumferential surface of the spark plug between the sealing part and the connecting part.

The sealing part may be an O-ring formed of an aluminum material.

The valve may be connectable to a gas injection apparatus so that the gas injection apparatus injects an inert gas into the space.

The oxygen and moisture removal apparatus may be installed in plural on the lid.

The plurality of the oxygen and moisture removal apparatuses may be installed so as to be spaced apart from each other by a predetermined distance or more.

The oxygen and moisture removal apparatus may be the spark plug including: the connecting part that includes the screw thread formed the outer circumferential surface of one side thereof to be screw-connected with the lid; the sealing part that is installed at a portion in contact with the lid to seal the lid when screw-connected with the lid; the oxygen removal unit that generates the flame, and is installed at one end of one side thereof and located inside the space when the oxygen and moisture removal apparatus is connected to the lid; and the moisture removal unit that absorbs the moisture, and is installed between the sealing part and the oxygen removal unit and located inside the space when the oxygen and moisture removal apparatus is connected to the lid.

The moisture removal unit may be formed by coating silicon dioxide on an outer circumferential surface of the spark plug between the sealing part and the connecting part.

The sealing part may be an O-ring formed of an aluminum material.

Details of other embodiments for solving the problem are included in the description and drawings of the invention.

### Advantageous Effects

According to the means to be solved by the present disclosure as described above, according to a spent nuclear fuel dry storage container having internal oxygen and moisture removal functions according to the present disclosure, since an oxygen removal unit can generate a flame to combust oxygen remaining in the space, it is possible to prevent the spent nuclear fuel dry storage container having internal oxygen and moisture removal functions from being oxidized and damaged, thereby preventing the spent nuclear fuel from leaking to the outside.

In addition, since the moisture removal unit can absorb moisture and absorb the moisture remaining in the space, it is possible to prevent the spent nuclear fuel dry storage container having internal oxygen and moisture removal functions from being oxidized and damaged, thereby preventing the spent nuclear fuel from leaking to the outside.

In addition, since a plurality of oxygen and moisture removal apparatuses are distributed and arranged inside the space so as to be spaced apart from each other by a predetermined distance or more, it is possible to more effectively prevent the spent nuclear fuel dry storage container having internal oxygen and moisture removal functions from being oxidized and damaged, thereby preventing the spent nuclear fuel from leaking to the outside.

### BRIEF DESCRIPTION OF THE DRAWINGS

FIG. 1 is a cross-sectional view illustrating a front of a spent nuclear fuel dry storage container having internal oxygen and moisture removal functions according to a first embodiment of the present disclosure.

FIG. 2 is a diagram illustrating an example of an oxygen and moisture removal apparatus.

FIG. 3 is a cross-sectional view illustrating a front of a spent nuclear fuel dry storage container having internal oxygen and moisture removal functions according to a second embodiment of the present disclosure.

FIG. 4 is a plan view illustrating a lid on which an oxygen and moisture removal apparatus is installed.

### BEST MODE

Hereinafter, exemplary embodiments of the present disclosure will be described in detail with reference to the accompanying drawings so that those skilled in the art to which the present disclosure pertains may easily practice. However, the present disclosure may be implemented in various different forms, and is not limited to the embodiments described herein. In addition, in the drawings, portions unrelated to the description will be omitted to clearly describe the present disclosure, and similar portions will be denoted by similar reference numerals throughout the specification.

Throughout the present specification, when any one part is referred to as being “connected to” another part, it means that any one part and another part are “directly connected to” each other or are “electrically connected to” each other with still another part interposed therebetween.

Throughout the present specification, when any member is referred to as being located “on” other member, it includes not only a case in which any member and another member are in contact with each other, but also a case in which the other member is interposed between any member and another member.

Throughout the present specification, “including” any component will be understood to imply the inclusion of other components rather than the exclusion of other components, unless explicitly described to the contrary. The terms “about,” “substantially,” and the like used throughout the present specification means figures corresponding to manufacturing and material tolerances specific to the stated meaning and figures close thereto, and are used to prevent unconscionable abusers from unfairly using the disclosure of figures precisely or absolutely described to aid the understanding of the present disclosure. The term “˜step” or “˜step of” used throughout the present specification of the present disclosure does not mean “˜step for.”

Hereinafter, exemplary embodiments of the present disclosure will be described in detail with reference to the accompanying drawings. However, the present disclosure is not limited to exemplary embodiments herein, but may be implemented in other forms. Same reference numerals denote same constituent elements throughout the specification.

Hereinafter, a configuration of a spent nuclear fuel dry storage container having internal oxygen and moisture removal functions according to a first embodiment of the present disclosure will be described.

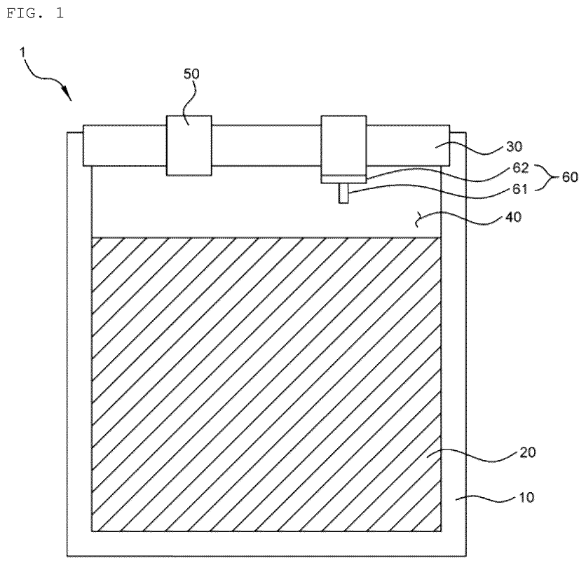

FIG. 1 is a cross-sectional view illustrating a front of a spent nuclear fuel dry storage container having internal oxygen and moisture removal functions according to a first embodiment of the present disclosure.

Referring to FIG. 1, a spent nuclear fuel dry storage container 1 having internal oxygen and moisture removal functions includes a main body 10, a lid 30, a valve 50, and an oxygen and moisture removal apparatus 60.

First, the main body 10 will be described.

The main body 10 is formed to include a lower surface and side surfaces so that a space 40 capable of accommodating radioactive waste 20 is formed inside.

The lower surface may be formed in a flat plate shape, and the side surfaces may be formed in a curved surface forming a closed loop. For example, the side surfaces may be formed in a hollow cylindrical shape so that a cross section parallel to the lower surface is circular.

The main body 10 may be formed of a metal material. For example, the main body 10 may be formed by a casting method of pouring lead or cast iron into a mold, and then a coating layer formed of a metal film or a plastic material may be plated or coated on a surface.

Since the main body 10 is formed to have an open upper portion, spent nuclear fuel 20 may be introduced through the open upper portion and accommodated in the space 40. The spent nuclear fuel 20 accommodated in the space 40 may be spent nuclear fuel generated during mining, refining, conversion, enrichment, fuel processing, nuclear power plant operation, reprocessing, nuclear facility dismantling, etc.

Next, the lid 30 will be described.

The lid 30 may be formed to be fastened to an upper portion of the main body 10 to seal the space 40, and for example, the lid 30 may be formed in a flat plate shape having a predetermined thickness.

The lid 30 may be fastened to the upper portion of the main body 10 in various known ways. For example, the lid 30 may be fastened to the upper portion of the main body 10 in a bolt-fastening manner or by welding.

The lid 30 may be formed of a metal material like the main body 10. For example, the lid 30 may be formed by a casting method of pouring lead or cast iron into a mold, and then the coating layer formed of a metal film or a plastic material may be plated or coated on the surface.

Meanwhile, a valve 50 and an oxygen and moisture removal apparatus 60 to be described later may be installed on the lid 30.

Next, the valve 50 will be described.

The valve 50 may be configured as a conventional valve that is installed on the lid 30 and may make the space 40 and the outside of the spent nuclear fuel dry storage container 1 having internal oxygen and moisture removal functions communicate with and isolate from each other. For example, the valve 50 may be configured as the conventional valve that may be opened and closed so as to make the space 40 and the outside of the spent nuclear fuel dry storage container 1 having internal oxygen and moisture removal functions communicate with each other when opened, and isolate the space 40 and the outside of the spent nuclear fuel dry storage container 1 having internal oxygen and moisture removal functions from each other when closed.

In addition, although not illustrated in the drawings, a gas suction apparatus capable of sucking gas or a gas injection apparatus capable of injecting gas may be connected to the valve 50.

The gas suction apparatus may be connected to the valve 50 to prevent the spent nuclear fuel dry storage container 1 having internal oxygen and moisture removal functions from being oxidized and may form the inside of the space 40 into a vacuum state by sucking gas such as oxygen contained in the space 40.

Specifically, when the gas suction apparatus is connected to the valve 50 and the valve 50 is opened, the gas suction apparatus may suck gas contained in the space 40 and form the inside of the space 40 into the vacuum state. Next, when the valve 50 is closed and the connection between the valve 50 and the gas suction apparatus is disconnected, the spent nuclear fuel dry storage container 1 having internal oxygen and moisture removal functions in which the inside of the space 40 is formed in the vacuum state is prepared.

The gas injection apparatus may be connected to the valve 50 to inject an inert gas such as helium into the inside of the space 40 so that the spent nuclear fuel 20 accommodated in the space 40 is stably stored in the spent nuclear fuel dry storage container 1 having internal oxygen and moisture removal functions.

Specifically, when the gas injection apparatus is connected to the valve 50 and the valve 50 is opened, the gas injection apparatus may inject the inert gas into the inside of the space 40. Next, when the valve 50 is closed and the connection between the valve 50 and the gas injection apparatus is disconnected, the spent nuclear fuel dry storage container 1 having internal oxygen and moisture removal functions in which the inside of the space 40 is filled with the inert gas is prepared.

Next, the oxygen and moisture removal apparatus 60 will be described.

The oxygen and moisture removal apparatus 60 may be installed in the lid 30 and includes an oxygen removal unit 61 capable of removing oxygen contained in the space 40 and a moisture removal unit 62 capable of removing moisture contained in the space 40.

The oxygen removal unit 61 may be formed to be located inside the space 40 when the lid 30 is fastened to the main body 10 and may be configured to generate a flame and combust oxygen contained in the space 40.

In addition, the moisture removal unit 62 may be formed to be located inside the space 40 when the lid 30 is fastened to the main body 10 and may be configured to absorb moisture and remove moisture contained in the space 40.

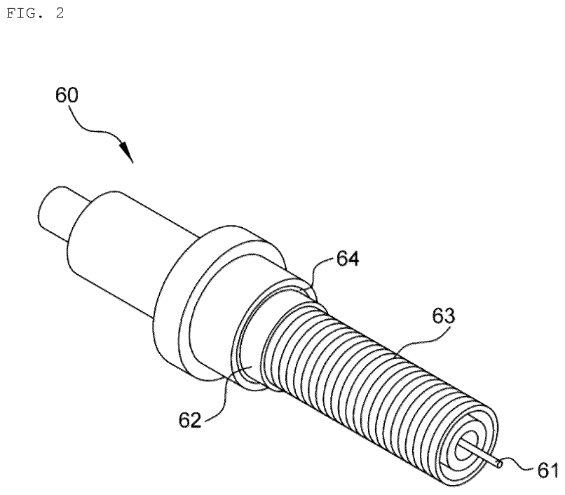

FIG. 2 is a diagram illustrating an example of the oxygen and moisture removal apparatus.

Specifically, as illustrated in FIG. 2, the oxygen and moisture removal apparatus 60 may be composed of a spark plug including the oxygen removal unit 61, the moisture removal unit 62, a connecting part 63, and a sealing part 64.

The connecting part 63 may include a screw thread formed on an outer circumferential surface of one side thereof so that the oxygen and moisture removal apparatus 60, which is a spark plug, may be screw-connected with the lid 30. For example, when a hole with a screw groove is formed in the lid 30, the oxygen and moisture removal apparatus 60 may be installed on the lid 30 by screw-connecting the screw thread of the connecting part 63 to the screw groove of the hole.

The sealing part 64 may be installed at a portion of the oxygen and moisture removal apparatus 60 that comes into contact with the lid 30 so as to seal the lid 30 when the oxygen and moisture removal apparatus 60 is screw-connected to the lid 30. For example, the sealing part 64 may be configured as an O-ring formed of an aluminum material.

The oxygen removal unit 61 can generate a flame and is installed at an end of one side of the oxygen and moisture removal apparatus 60. When the oxygen and moisture removal apparatus 60 is connected to the lid 30, the oxygen and moisture removal apparatus 60 may be located inside the space 40.

When the oxygen and moisture removal apparatus 60 is connected to a power supply apparatus capable of supplying power and is supplied with power, the oxygen removal unit 61 may generate a flame for a predetermined period of time to combust the oxygen contained in the space 40. In this case, the time when the flame is generated in the oxygen removal unit 61 may be a short time of several milliseconds (ms).

The moisture removal unit 62 can absorb moisture and is installed between the sealing part 64 and the oxygen removal unit 61, so, when the oxygen and moisture removal apparatus 60 is connected to the lid 30, the moisture removal unit 62 may be located inside the space 40.

For example, the moisture removal unit 62 may be formed by coating the outer circumferential surface of the oxygen and moisture removal apparatus 60 between the sealing part 64 and the connecting part 63 with silicon dioxide that absorbs moisture.

Meanwhile, when the space 40 is formed in the vacuum state by the gas suction apparatus, the tiny amount of oxygen remains in the space 40 of the spent nuclear fuel dry storage container 1 having internal oxygen and moisture removal functions, so the oxygen removal unit 61 may combust the oxygen contained in the space 40 even if it generates a flame for a relatively short time of period.

Likewise, when the space 40 is formed in the vacuum state by the gas suction apparatus, the tiny amount of moisture remains in the space 40 of the spent nuclear fuel dry storage container 1 having internal oxygen and moisture removal functions, so that the moisture removal unit 62 may remove the moisture contained in the space 40 even if it absorbs a relatively small amount of moisture.

Hereinafter, a configuration of a spent nuclear fuel dry storage container 2 having internal oxygen and moisture removal functions according to a second embodiment of the present disclosure will be described.

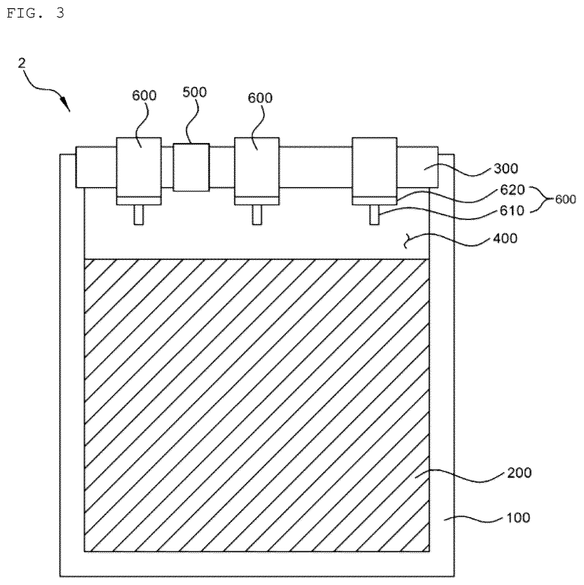

FIG. 3 is a cross-sectional view illustrating a front of a spent nuclear fuel dry storage container having internal oxygen and moisture removal functions according to a second embodiment of the present disclosure.

Referring to FIG. 3, a spent nuclear fuel dry storage container 2 having internal oxygen and moisture removal functions includes a main body 100, a lid 300, a valve 500, and an oxygen and moisture removal apparatus 600.

First, the main body 100 will be described.

The main body 100 is formed to include a lower surface and side surfaces so that a space 400 capable of accommodating spent nuclear fuel 200 is formed inside.

A specific configuration of the main body 100 is the same as the configuration of the main body 10 of the spent nuclear fuel dry storage container 1 having internal oxygen and moisture removal functions, so a detailed description thereof will be omitted.

Next, the lid 300 will be described.

The lid 300 may be formed to be fastened to an upper portion of the main body 100 to seal the space 400, and for example, the lid 300 may be formed in a flat plate shape having a predetermined thickness.

A specific configuration of the lid 300 is the same as the configuration of the lid 30 of the spent nuclear fuel dry storage container 1 having internal oxygen and moisture removal functions, so a detailed description thereof will be omitted.

Next, the valve 500 will be described.

The valve 500 may be configured as a conventional valve that is installed on the lid 300 and may make the space 400 and the outside of the spent nuclear fuel dry storage container 2 having internal oxygen and moisture removal functions communicate with and isolate from each other.

A specific configuration of the valve 500 is the same as the configuration of the valve 50 of the spent nuclear fuel dry storage container 1 having internal oxygen and moisture removal functions, so a detailed description thereof will be omitted.

Next, the oxygen and moisture removal apparatus 600 will be described.

The plurality of oxygen and moisture removal apparatuses 600 may be installed in the lid 300 and includes an oxygen removal unit 610 capable of removing oxygen contained in the space 400 and a moisture removal unit 620 capable of removing moisture contained in the space 400.

The oxygen removal unit 610 may be formed to be located inside the space 400 when the lid 300 is fastened to the main body 100 and may be configured to generate a flame and combust oxygen contained in the space 400.

In addition, the moisture removal unit 620 may be formed to be located inside the space 400 when the lid 300 is fastened to the main body 100 and may be configured to absorb moisture and remove moisture contained in the space 400.

Similar to the oxygen and moisture removal apparatus 60 of the spent nuclear fuel dry storage container 1 having internal oxygen and moisture removal functions, the oxygen and moisture removal apparatus 600 may be configured as a spark plug, and its specific configuration is the same as the oxygen and moisture removal apparatus 60, so a detailed description thereof is omitted below.

Meanwhile, the plurality of oxygen and moisture removal apparatuses 600 installed on the lid 300 may be distributed and arranged to be spaced apart from each other by a predetermined distance or more.

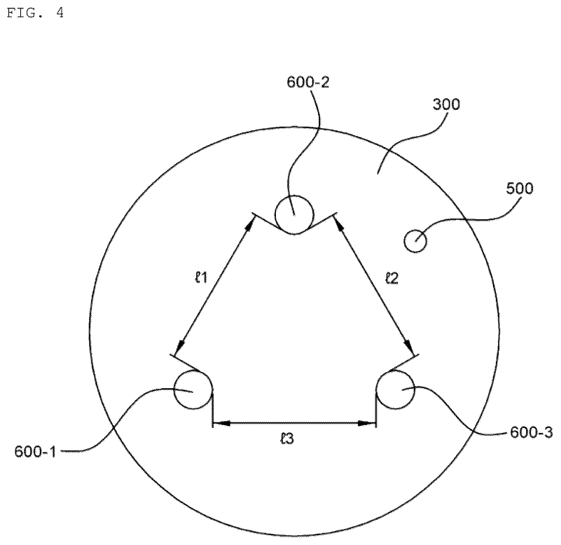

FIG. 4 is a plan view illustrating a lid on which an oxygen and moisture removal apparatus is installed.

For example, as illustrated in FIG. 4, a first oxygen and moisture removal apparatus 600-1, a second oxygen and moisture removal apparatus 600-2, and a third oxygen and moisture removal apparatus 600-3 may be installed in the lid 300.

A first distance 11 at which the first oxygen and moisture removal apparatus 600-1 and the second oxygen and moisture removal apparatus 600-2 are spaced apart from each other, a second distance 12 at which the second oxygen and moisture removal apparatus 600-2 and the third oxygen and moisture removal apparatus 600-3 are spaced apart from each other, and a third distance 13 at which the third oxygen and moisture removal apparatus 600-3 and the first oxygen and moisture removal apparatus 600-1 are spaced apart from each other may all be equal to or longer than a predetermined distance.

In this way, if the plurality of oxygen and moisture removal apparatuses 600 are installed on the lid 300 so that the distance therebetween is a predetermined distance or more, when the lid 300 is fastened to the main body 100, the plurality of oxygen and moisture removal apparatuses 600 may be distributed and arranged inside the space 400 so that the distance therebetween is a predetermined distance or more.

In addition, when a volume of the spent nuclear fuel dry storage container 2 having internal oxygen and moisture removal functions is relatively large and a volume of the space 400 is relatively large, the oxygen remaining in the space 400 is scattered and distributed in the wide space 400, and when the plurality of oxygen and moisture removal apparatuses 600 are distributed and arranged inside the space 400 so that the distance therebetween is a predetermined distance or more and the flame is generated in each oxygen and moisture removal apparatus 600, the oxygen scattered and distributed throughout the wide space 400 may be effectively removed.

Hereinafter, the operation and effect of the spent nuclear fuel dry storage container having internal oxygen and moisture removal functions of the present disclosure will be described.

When the spent nuclear fuels 20 and 200 are accommodated in the spaces 40 and 400 formed in main bodies 10 and 100, the lids 30 and 300 are fastened to the main bodies 10 and 100 to seal the spaces 40 and 400.

When the spaces 40 and 400 are sealed, the gas suction apparatus are connected to the valves 50 and 500, and the valves 50 and 500 are opened to suck gas contained in the spaces 40 and 400 into the gas suction apparatus. When all the gas contained in the spaces 40 and 400 is sucked into the gas suction apparatus, the valves 50 and 500 are closed to form the inside of the spaces 40 and 400 into a vacuum state.

When the inside of the spaces 40 and 400 is in the vacuum state, the gas injection apparatus is connected to the valves 50 and 500, and the valves 50 and 500 are opened to inject the inert gas into the spaces 40 and 400 using the gas injection apparatus. When a predetermined amount of inert gas is injected into the spaces 40 and 400, the valves 50 and 500 are closed to isolate the inside of the spaces 40 and 400 and the outside of the spent nuclear fuel dry storage containers 1 and 2 having internal oxygen and moisture removal functions from each other.

Next, power is supplied to the oxygen and moisture removal apparatuses 60 and 600 to generate the flame in the oxygen removal units 61 and 610. When the flame is generated in the oxygen removal units 61 and 610, a tiny amount of oxygen contained in the spaces 40 and 400 is combusted and removed.

Meanwhile, since the oxygen and moisture removal apparatuses 60 and 600 include the moisture removal units 62 and 620 that absorb moisture, a tiny amount of moisture contained in the spaces 40 and 400 is also removed.

In this way, according to the spent nuclear fuel dry storage container having internal oxygen and moisture removal functions according to the present disclosure, since the oxygen removal unit can generate the flame to combust the oxygen remaining in the space, it is possible to prevent the spent nuclear fuel dry storage container having internal oxygen and moisture removal functions from being oxidized and damaged, thereby preventing the nuclides from leaking to the outside.

In addition, since the moisture removal unit can absorb moisture and absorb the moisture remaining in the space, it is possible to prevent the spent nuclear fuel dry storage container having internal oxygen and moisture removal functions from being oxidized and damaged, thereby preventing the nuclides from leaking to the outside.

In addition, since the plurality of oxygen and moisture removal apparatuses are arranged to be evenly distributed inside the space to effectively remove the oxygen remaining in the space, it is possible to more effectively prevent the spent nuclear fuel dry storage container having internal oxygen and moisture removal functions from being oxidized and damaged, thereby preventing the nuclides from leaking to the outside.

The description of the present disclosure provided above is illustrative, and it is to be understood by those skilled in the art that various modifications and alterations may be made without departing from the spirit or essential feature of the present disclosure. Therefore, it is to be understood that the exemplary embodiments described above are illustrative rather than being restrictive in all aspects. For example, respective components described as a single form may be implemented in a distributed manner, and similarly, components described as being distributed may also be implemented in a combined form.

It is to be understood that the scope of the present disclosure will be defined by the claims rather than the above-described description and all modifications and alternations derived from the claims and their equivalents are included in the scope of the present disclosure.

1. A spent nuclear fuel dry storage container having internal oxygen and moisture removal functions for storing and transporting spent nuclear fuel, comprising:
a main body that is formed to include a lower surface and side surfaces so that a space accommodating the spent nuclear fuel is formed inside, and an open upper surface;
a lid that is fastened to an upper portion of the main body to seal the space;
a valve that is installed on the lid configured to open and close so as to make the space and an outside of the spent nuclear fuel dry storage container having internal oxygen and moisture removal functions communicate with each other when opened, and isolate the space and the outside of the spent nuclear fuel dry storage container having internal oxygen and moisture removal functions from each other when closed, the valve connectable to a gas suction apparatus so that the gas suction apparatus sucks gas contained in the space; and
an oxygen and moisture removal apparatus that is installed on the lid and includes an oxygen removal unit removing oxygen contained in the space and a moisture removal unit removing moisture contained in the space.

2. The spent nuclear fuel dry storage container of claim 1, wherein the oxygen removal unit generates a flame and combusts oxygen contained in the space, and the moisture removal unit absorbs moisture and removes moisture contained in the space.

3. The spent nuclear fuel dry storage container of claim 2, wherein the oxygen and moisture removal apparatus is a spark plug including:
a connecting part that includes a screw thread formed on an outer circumferential surface of one side thereof so as to be screw-connected with the lid;
a sealing part that is installed in a portion in contact with the lid to seal the lid when screw-connected with the lid;
the oxygen removal unit that generates the flame, and is installed at an end of one side thereof and located inside the space when the oxygen and moisture removal apparatus is connected to the lid; and
the moisture removal unit that absorbs the moisture, and is installed between the sealing part and the oxygen removal unit and located inside the space when the oxygen and moisture removal apparatus is connected to the lid.

4. The spent nuclear fuel dry storage container of claim 3, wherein the moisture removal unit is formed by coating silicon dioxide on an outer circumferential surface of the spark plug between the sealing part and the connecting part.

5. The spent nuclear fuel dry storage container of claim 4, wherein the sealing part is an O-ring formed of an aluminum material.

6. The spent nuclear fuel dry storage container of claim 5, wherein the valve is connectable to a gas injection apparatus so that the gas injection apparatus injects an inert gas into the space.

7. The spent nuclear fuel dry storage container of claim 2, wherein the lid comprises a plurality of oxygen and moisture removal apparatuses.

8. The spent nuclear fuel dry storage container of claim 7, wherein the plurality of oxygen and moisture removal apparatuses are installed so as to be spaced apart from each other by a predetermined distance or more.

9. The spent nuclear fuel dry storage container of claim 8, wherein the oxygen and moisture removal apparatus is a spark plug including:
a connecting part that includes a screw thread formed on an outer circumferential surface of one side thereof to be screw-connected with the lid;
a sealing part that is installed at a portion in contact with the lid to seal the lid when screw-connected with the lid;
the oxygen removal unit that generates the flame, and is installed at one end of one side thereof and located inside the space when the oxygen and moisture removal apparatus is connected to the lid; and
the moisture removal unit that absorbs the moisture, and is installed between the sealing part and the oxygen removal unit and located inside the space when the oxygen and moisture removal apparatus is connected to the lid.

10. The spent nuclear fuel dry storage container of claim 9, wherein the moisture removal unit is formed by coating silicon dioxide on an outer circumferential surface of the spark plug between the sealing part and the connecting part.

11. The spent nuclear fuel dry storage container of claim 10, wherein the sealing part is an O-ring formed of an aluminum material.
